(19) United States
(12) Patent Application Publication
(10) Pub. No.: US 2012/0060659 A1
(43) Pub. Date: Mar. 15, 2012

(54) APPARATUS AND METHOD FOR SETTING A CUTTING GAP AT A CUTTING APPARATUS

(75) Inventor: Günther Weber, Gross Nemerow (DE)

(73) Assignee: Weber Maschinenbau GmbH Breidenbach, Breidenbach (DE)

(21) Appl. No.: 13/254,736

(22) PCT Filed: Mar. 3, 2010
(86) PCT No.: PCT/EP2010/001344

§ 371 Date: Nov. 18, 2011

(30) Foreign Application Priority Data
Mar. 5, 2009 (DE) 10 2009 011 860.8

(51) Int. Cl. B26D 5/00; B23Q 17/09

(52) U.S. Cl. 83/13; 83/72; 73/104

(57) ABSTRACT

The invention relates to a device and to a method for adjusting a blade clearance on a cutting device for slicing a product, in particular a food product (18), wherein the cutting device has a cutting blade (14) which can be rotatably driven in a cutting plane (12), a cutting edge (24) and an adjustment apparatus (28) by which the cutting blade (14) and the cutting edge (24) can be moved relative to each other perpendicular to the cutting plane (12).

The invention relates to an apparatus and to a method for setting a cutting gap at a cutting apparatus for slicing a product, in particular a food product, wherein the cutting apparatus has a blade rotatingly drivable in a cutting plane, a cutting edge and an adjustment device by which the blade and the cutting edge are movable relative to one another perpendicular to the cutting plane.

Such an apparatus and such a method are generally known and serve to set the cutting gap, i.e. that is the distance between the cutting plane and the cutting edge such that an ideal and unchanging cutting quality and placement quality as well as a maximum blade service life is achieved.

A product can generally be cut the better, the smaller the cutting gap is. This in particular applies when the blade no longer has its optimum sharpness. The cutting gap was, however, previously not able to be set as small as desired for the following reasons:

The blades of known cutting apparatus, in particular of known high-performance slicers which can carry out up to 2000 cuts per minute, are typically formed as circular blades or as scythe-like blades. These blades are products which have to be manufactured in a complex process and which can show wobble tolerances of up to 0.5 mm due to the manufacturing process.

The distance between the blade and the cutting edge with a stationary blade is conventionally determined at points by means of a manual measurement or by means of a distance sensor such as a laser sensor, an ultrasound sensor or an inductive sensor. Since it is not clear due to the point-specific character of the measurement whether the measured distance is actually a maximum distance or a minimum distance between the blade and the cutting edge, the possible wobble tolerance always has to be added to the measurement result. The setting of a cutting gap which is smaller than the wobble tolerance is consequently not possible.

The distance measurement or setting of the cutting gap with a stationary blade furthermore has the disadvantage that it remains out of consideration in this process that the blade bends up in the rotating state as the speed increases. The width of the cutting gap can additionally increase by several tenths of a millimeter by this effect.

In addition, the blade deforms during a cutting process by the effect of force on the product to be cut. This deformation depends on the kind of blade used as well as on the kind of product to be sliced and can likewise be in the range of several tenths of a millimeter, with the direction of the deformation depending on the respective cutting parameters as well as on the kind of blade and of product.

It is therefore the object of the invention to provide an apparatus and a method which allows, in particular automatically, an ideal cutting gap setting.

An apparatus having the features of claim 1 as well as a method having the features of claim 6 are provided to satisfy the object.

The invention is based on the general idea of carrying out the setting of the cutting gap not with a stationary blade, but with a rotating blade. This has the special advantage that a bending up of the blade due to rotation can be taken into account to the extent it actually occurs, i.e. correctly, in the setting of the cutting gap. The cutting gap can furthermore be set by the cutting gap setting with a rotating blade such that it actually corresponds to a desired minimum distance between the blade and the cutting edge. As a result, an ideal cutting gap setting is thus possible while taking account of the circumstances such as wobble and/or bending up of the blade which are actually present during a cutting process.

Specifically, the invention provides a detection of vibrations produced by the rotating blade and a control of the adjustment direction in dependence on the vibrations detected. This measure is based on the recognition that the rotating blade produces a characteristic vibration profile corresponding to its respective configuration, with the vibration profile being different in the freely rotating state of the blade than in a state in which the blade contacts the cutting edge.

While utilizing this difference in the vibration profile with a rotating blade, a zero distance of the blade from the cutting edge can be determined and, starting from this zero distance, an exact setting of the cutting gap can be carried out. The apparatus in accordance with the invention and the method in accordance with the invention consequently allow an automatic setting of an exact cutting gap while subtracting out the blade tolerances and the blade bending up.

Advantageous embodiments of the invention can be seen from the dependent claims, from the description and from the drawing.

In accordance with an embodiment of the apparatus in accordance with the invention, the detection means is designed for detecting sound waves, in particular structure-borne sound waves. The detected vibrations are in other words of a mechanical nature, but do not necessarily have to be perceivable by the human ear. It can rather in this respect be vibrations which are caused by the rotating blade in the components of the cutting apparatus.

To be able to detect a contact of the rotating blade with the cutting edge particularly reliably, the detection means is preferably arranged in the region of the cutting edge. The detection means can generally be mounted at the cutting edge itself.

The detection means is, however, advantageously attached to a carrier structure for the cutting edge and is in particular let into the carrier structure. A replacement of the cutting edge, which is subject to a certain wear, can take place by the attachment of the detection means to the carrier structure without taking account of the detection means and in particular without the detection means having to be dismantled from the cutting edge or having to be separated from an electrical connection for this purpose. The replacement of the cutting edge is hereby substantially simplified.

The detection means can include one or more structure-borne sound sensors. A structure-borne sound sensor does not have any preferred direction of detection, but rather detects an overall image of the vibrations present. The or each structure-borne sound sensor can be fastened to an outer surface of the carrier structure, in particular to a rear side of the carrier structure remote from the cutting plane. A simpler cleaning of the cutting apparatus, in particular in the region of the cutting edge, is possible when the or each structure-borne sound sensor is integrated in the carrier structure, for example in a correspondingly provided recess or in a correspondingly provided hollow space of the carrier structure. If a plurality of structure-borne sound sensors are used, it is advantageous to arrange them distributed over the width of the carrier structure, i.e. that is parallel to the cutting plane. In this respect, the plurality of structure-borne sound sensors can each be accommodated in their own recess or in their own hollow space or in a common recess or in a common hollow space.

In accordance with a further embodiment, the control unit is designed to evaluate the detected vibrations with respect to their amplitude and/or frequency. This allows a monitoring of the vibrations produced by the freely rotating blade and in particular the detection of a difference of the detected vibrations from the characteristic vibration profile of the freely rotating blade, for example when the blade contacts the cutting edge. The control unit is hereby in a position to determine a zero distance between the blade and the cutting edge.

In accordance with an advantageous embodiment of the method in accordance with the invention, a reference vibration pattern is recorded while the blade is spaced apart from the cutting edge. The reference vibration pattern corresponds to the characteristic vibration profile of the freely rotating blade which does not contact the cutting edge. The reference vibration pattern is not necessarily constant viewed over the service life of a blade, but it can be influenced by various factors such as the quality of the blade support, the wear state, the wobble or another deformation of the blade.

The reference vibration pattern is preferably recorded while the blade is accelerated from a stationary state. This makes it possible to record a new reference vibration pattern after each replacement of the blade and to use it as the basis for the cutting gap setting, whereby an ideal cutting gap can be set individually for every newly installed blade.

Alternatively or additionally, the reference vibration blade can be recorded while the distance between the blade and the cutting edge is being reduced. This on the one hand precludes the case that a newly installed blade is again moved toward the cutting edge and the case that the rotating blade is first moved away from the cutting edge and then back to it during operation, e.g. for readjusting the cutting gap. Alternatively, the cutting edge can also be moved toward a stationary blade.

In accordance with a further embodiment of the method, a zero distance of the blade from the cutting edge is determined in that the distance between the blade and the cutting edge is reduced after the taking of a reference vibration pattern until a significant difference of the detected vibrations from the reference vibration pattern is detected. For example, a significant difference can be detected when the amplitude of at least one detected vibration exceeds the amplitude of the reference vibration pattern by a predetermined amount.

It is thus easy to reconstruct that, when the blade contacts the cutting edge, a vibration is generated in the cutting edge or in a carrier structure for the cutting edge whose amplitude is much larger than that of the vibrations of the reference vibration pattern. If this amplitude difference exceeds a predetermined threshold value, it can be assumed that the blade is coming into contact with the cutting edge.

The reliability of this detection of the zero distance between the blade and the cutting edge can be even further increased in that the frequency of a detected difference from the reference vibration pattern is put into relation with the speed of the rotating blade. A difference from the reference vibration pattern is thus produced with increased probability by the blade contacting the cutting edge when the frequency of the detected difference coincides at least substantially with the speed of the blade. In this manner, a difference from the reference vibration pattern caused by the rotating blade can be distinguished, for example, from a difference which is caused by external influences such as by knocking with a tool in the vicinity of the cutting apparatus.

The distance between the blade and the cutting edge is advantageously increased, starting from the determined zero distance, to set the desired cutting gap. The determined zero distance is in other words used as a zero point for the setting of the cutting gap. If the adjustment device has an actuation motor for moving the blade or the cutting edge, the setting of the desired cutting gap can take place based on the signals of a rotary encoder which allows a monitoring of the adjustment of the blade or of the cutting edge relative to the zero point. A distance sensor for determining the absolute distance between the cutting blade and the cutting edge can thus be dispensed with.

A further subject of the invention is moreover the use of a structure-borne sound sensor for determining a zero distance between the blade and the cutting edge on the setting of a cutting gap at a cutting apparatus for slicing a product, in particular a food product, which has a blade rotatingly drivable in a cutting plane, a cutting edge and an adjustment device by which the blade and the cutting edge are movable relative to one another perpendicular to the cutting plane.

The invention will be described in the following purely by way of example with reference to an advantageous embodiment and to the enclosed drawing. There are shown:

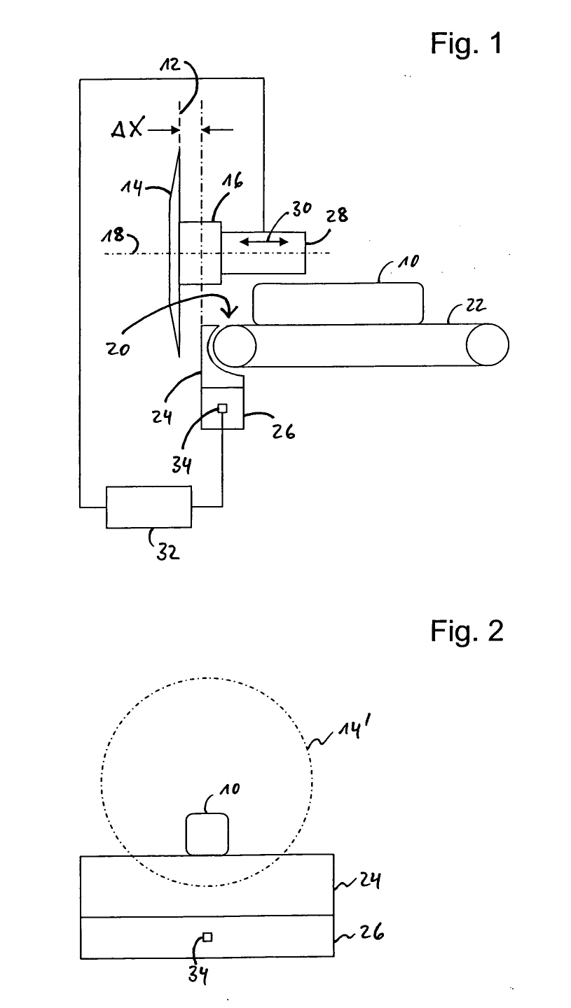

FIG. 1 a schematic side view of a cutting apparatus with an apparatus in accordance with the invention for setting a cutting gap; and

FIG. 2 a schematic view of the front side of a cutting edge of the cutting apparatus of FIG. 1.

The cutting apparatus shown in FIGS. 1 and 2 for cutting a product, in particular a food product 10, has a blade 14 which is rotatingly drivable in a cutting plane 12 and which is fastened to a blade head 16. In the present embodiment, the blade 14 is a scythe-like blade which rotates exclusively about its center axis 18 and in so doing describes a peripheral circle which is designated by the reference numeral 14′ in FIG. 2. Alternatively, the blade head 16 can be driven circulating in a planetary motion so that the blade 14 rotates on a planetary orbit in addition to its own rotation abut the center axis 18.

The food product 10 to be sliced lies on a product support 20 on which it is moved in the direction of the cutting plane 12. In the present embodiment, the product support 20 includes a conveyor belt 22. Instead of the conveyor belt 22, the product support 20 can, however, also include a stationary support on which the food product 10 is pushed in the direction of the cutting plane 12 with the help of a gripper. Such a gripper can naturally also be used in connection with the conveyor belt 22.

The front end of the product support 20 forms a cutting edge 24 with which the blade 14 cooperates in cutting. So that the cutting edge 24 can be replaced for matching of the cutting apparatus to the respective application or also on excessive wear, it is releasably fastened to a carrier structure 26 which extends transversely to the conveying direction of the food product 10 beneath the conveyor belt 22. The carrier structure 26 is also called a cutting edge mount here.

A cutting gap Δx is formed between the cutting plane 12 and the cutting edge 24 and is shown in highly magnified form in FIG. 1.

The blade head 16 and the blade 14 fastened thereto are displaceably supported on an electrical adjustment apparatus 28 such that the blade 14 can be moved toward or away from the cutting edge 24, which is indicated in FIG. 1 by a double arrow 30. It would alternatively also be possible to support the blade 14 in a fixed position and to move the cutting edge 24 relative thereto. A control unit 32 is provided for the automatic control of the adjustment device 28.

A structure-borne sound sensor 34 is attached to the carrier structure 26 and communicates with the control unit 32. In the present embodiment, the structure-borne sound sensor 34 is let into the carrier structure 26, i.e. is arranged in a correspondingly formed hollow space (not shown) of the carrier structure 26. It is, however, generally also conceivable to fasten the structure-borne sound sensor 34 to an outer surface of the carrier structure 26, in particular to a rear side of the carrier structure 26 remote from the cutting plane 12.

Furthermore, in the present embodiment, only a structure-borne sound sensor 34 is used which is arranged substantially centrally in the carrier structure 26. A use of a plurality of structure-borne sound sensors is, however, also conceivable which can e.g. be arranged distributed over the width of the carrier structure 26, i.e. that is viewed transversely to the conveying direction of the food product 10.

The structure-borne sound sensor 34 detects the mechanical oscillations or vibrations present in the carrier structure 26 in dependence on the direction; in other words that is the structure-borne sound induced in the carrier structure 26. The vibrations detected by the structure-borne sound sensor 34 are evaluated by the control unit 32 with respect to their amplitudes or frequencies, as will be explained in more detail in the following.

An ideal cutting result is achieved when—in addition to other factors known per se—the food product 10 is sliced with a blade 14 which is as sharp as possible and with a cutting gap Δx which is as small as possible. Since the blade 14 becomes blunt after a certain number of cuts, the blade 14 must be replaced at regular intervals. In this respect, the cutting gap has to be set again after each blade replacement. A further reason for the replacement of the blade 14 can moreover be the change of the equipment, in particular of the blade 14 and/or of the cutting edge 24, for matching the cutting apparatus to a different application.

To set the cutting gap, the newly installed blade 14 is first accelerated from its stationary state to its operating speed, which can lie, for example, in the range between 500 and 2000 revolutions per minute. The operating speed is here understood as that speed of the blade 14 at which the food product 10 is ultimately sliced.

As soon as the blade 14 has reached a certain measurement speed, for example its operating speed, the vibrations induced in the carrier structure 26 are detected by the structure-borne sound sensor 34 and are stored in a memory of the control unit 32 as a reference vibration pattern.

After the taking of the reference vibration pattern, the blade 14 is moved so closely toward the cutting edge 24 in discrete steps by the adjustment device 28 until the control device 32 detects a significant difference of the vibrations detected by the structure-borne sound sensor 34 from the reference vibration pattern.

A significant difference can be, for example, that the amplitude of one or more vibrations is increased with respect to a mean or maximum vibration amplitude of the reference vibration pattern such that the resulting amplitude difference exceeds a predetermined threshold value, while simultaneously the frequency of this vibration or of these vibrations with an increased amplitude substantially coincides with the speed of the blade 14.

If the control unit 32 has detected such a significant difference from the reference vibration pattern in the vibrations detected by the structure-borne sound sensor 34, the control unit 32 assumes that a contact is present between the blade 14 and the cutting edge 24.

As a consequence of this, the movement of the blade 14 in the direction of the cutting edge 24 is stopped and the instantaneous position of the blade 14 is defined as the zero distance. In other words, the control unit 32 assumes that the distance between the blade 14 and the cutting edge 24 is zero in this situation.

Starting from this zero distance, the blade 14—controlled by the control unit 32—is subsequently moved away from the cutting edge 24 by a predetermined length amount to set a desired cutting gap Δx. This desired cutting gap Δx is preferably selected to be just so large that a deformation of the blade 14 during the cutting process does not result in a blade break, but is simultaneously so small that an ideal cutting result is achieved.

The setting of the desired cutting gap can in this respect take place in a manner known per se using a rotary encoder connected to the control unit 32, said rotary encoder monitoring the rotation of an output shaft of an electric motor of the adjustment device 28 responsible for the adjustment of the blade 14.

As soon as the desired cutting gap Δx has been set, the slicing of the food product 10 can be started in that it is supplied with the help of the conveyor belt 22 and/or of a product gripper to the blade 14.

As was explained above, in the present embodiment, the reference vibration pattern is only stored when the blade 14 has reached its measurement speed. This can, for example, be the operating speed at which the food product 10 is subsequently sliced. It is, however, also generally conceivable to define those vibrations as a reference vibration pattern which were already recorded during a lower speed, for example in the range between 500 and 1200 revolutions per minute.

If the determination of the zero distance between the blade 14 and the cutting edge 24 takes place at a speed of the blade 14 different from the measurement speed, this different speed of the blade 14 is to be taken into account in the detection and evaluation of a significant difference of the detected vibrations from the reference vibrations.

It must furthermore be noted that neither the taking of the reference vibration pattern nor the determination of the zero distance between the blade 14 and the cutting edge 24 requires a constant speed of the blade 14, i.e. that is s stationary operation of the blade 14. It is rather the case that both the taking of the reference vibration pattern and the determination of the zero distance between the blade 14 and the cutting edge 24 and/or the subsequent setting of the desired cutting gap Δx can take place while the speed of the blade 14 is still increasing. In this manner, the setting of the desired cutting gap Δx can be concluded up to the reaching of the operating speed of the blade 14 so that a continuation of the cutting process is possible as fast as possible after a replacement of the blade 14.

It must finally also be pointed out that the setting of the desired cutting gap Δx cannot only take place after a replacement of the blade 14. It is rather also possible to repeat the determination of the zero distance between the blade 14 and the cutting edge 24 and the subsequent setting of the desired cutting gap Δx during an ongoing cutting process, for example during so-called blank cuts, in which the food product 10 is temporarily retracted from the engagement region of the blade 14. This also allows a readjustment of the cutting gap Δx during ongoing operation.

### REFERENCE NUMERAL LIST

10 food product
12 cutting plane
14 blade
14′ peripheral circle
16 blade head
18 center axis
20 product support
22 conveyor belt
24 cutting edge
26 carrier structure
28 adjustment device
30 double arrow
32 control unit
34 structure-borne sound sensor

1-15. (canceled)

16. An apparatus for setting a cutting gap (Δx) at a cutting apparatus for slicing a product, wherein the cutting apparatus has a blade (14) rotatingly drivable in a cutting plane (12), a cutting edge (24) and an adjustment device (28) by which the blade (14) and the cutting edge (24) can be moved relative to one another perpendicular to the cutting plane (12), wherein a detection means (34) for detecting vibrations produced by the rotating blade (14) and a control unit (32) connected to the detection means (34) for controlling the adjustment device (28) in dependence on the detected vibrations.

17. An apparatus in accordance with claim 16, wherein the detection means (34) is designed for detecting sound waves, and/or wherein the detection means (34) includes a sound sensor.

18. An apparatus in accordance with claim 16, wherein the detection means (34) is designed for detecting structure-borne sound waves.

19. An apparatus in accordance with claim 18, wherein the detection means includes at least one structure-borne sound sensor.

20. An apparatus in accordance with claim 16, wherein the detection means (34) is arranged in the region of the cutting edge (24).

21. An apparatus in accordance with claim 16, wherein the detection means (34) is attached to a carrier structure (26) for the cutting edge (24).

22. An apparatus in accordance with claim 21, wherein the detection means is let into the carrier structure (26).

23. An apparatus in accordance with claim 16, wherein the control unit (32) is designed to evaluate the detected vibrations with respect to their amplitude and/or frequency and/or to determine a zero distance between the blade (14) and the cutting edge (24).

24. A method for setting a cutting gap (Δx) at a cutting apparatus for slicing a product, wherein the cutting apparatus has a blade (14) rotatingly drivable in a cutting plane (12), a cutting edge (24) and an adjustment device (28) by which the blade (14) and the cutting edge (24) can be moved relative to one another perpendicular to the cutting plane (12), wherein vibrations produced by the rotating blade (14) are detected by means of a detection means (34) and the adjustment device (28) is controlled in dependence on the detected vibrations by means of a control unit (32) connected to the detection means.

25. A method in accordance with claim 24, wherein sound waves produced by the rotating blade (14) are detected by means of the detection means (34).

26. A method in accordance with claim 25, wherein structure-borne sound waves produced by the rotating blade (14) are detected by means of the detection means (34).

27. A method in accordance with claim 25, wherein the vibrations are detected in the region of the cutting edge (24).

28. A method in accordance with claim 26, wherein the structure-borne sound waves are detected in the region of the cutting edge (24).

29. A method in accordance with claim 25, wherein a reference vibration pattern is recorded while the blade (14) is spaced apart from the cutting edge (24).

30. A method in accordance with claim 30, wherein the reference vibration pattern is recorded while the blade (14) is accelerated from a stationary state.

31. A method in accordance with claim 30, wherein the reference vibration pattern is recorded while the spacing between the blade (14) and the cutting edge (24) is being reduced.

32. A method in accordance with claim 25, wherein a zero spacing of the blade (14) from the cutting edge (24) is determined in that the spacing between the blade (14) and the cutting edge (24) is reduced after the taking of a reference vibration pattern until a significant difference of the detected vibrations from the reference vibration pattern is detected.

33. A method in accordance with claim 32, wherein a significant difference is detected when the amplitudes of detected vibrations exceed the amplitudes of the reference vibration pattern by a predetermined amount.

34. A method in accordance with claim 32, wherein the spacing between the blade (14) and the cutting edge (24) for setting the cutting gap (Δx) is enlarged starting from the determined zero spacing.

35. Use of a structure-borne sound sensor (34) for determining a zero spacing between the blade (14) and the cutting edge (24) in the setting of a cutting gap (Δx) at a cutting apparatus for slicing a product, which has a blade (14) rotatingly drivable in a cutting plane (12), a cutting edge (24) and an adjustment device (28) by which the blade (14) and the cutting edge (24) can be moved relative to one another perpendicular to the cutting plane (12).
